(19) United States
(12) Patent Application Publication
(10) Pub. No.: US 2023/0171684 A1
(43) Pub. Date: Jun. 1, 2023

(54) CROSS-SIM CALLING USING NETWORK SLICE WITH QOS

(71) Applicant: GOOGLE LLC, Mountain View, CA (US)

(72) Inventor: Sooraj Sasindran, San Diego, CA (US)

(21) Appl. No.: 18/071,955

(22) Filed: Nov. 30, 2022

Related U.S. Application Data
(63) Continuation of application No. PCT/US2021/061095, filed on Nov. 30, 2021.

(51) Int. Cl. H04W 48/18; H04W 76/12

(52) U.S. Cl. CPC H04W 48/18; H04W 76/12; H04W 88/06

(57) ABSTRACT

A user equipment (UE) (102) employs cross-subscriber identity module (cross-SIM) calling by establishing a network tunnel (122) between the UE and a first cellular network (104-1) via a wireless connection (116) with a second cellular network (104-2). The wireless connection with the second cellular network is employed as part of a network slice (118) between the UE and the second cellular network that has one or more quality of service (QoS) capabilities suitable for conducting a call for the UE. Thus, the QoS support for the link between the UE and the second cellular network contributes to an overall QoS level for the call between the UE and the first cellular network.

### BACKGROUND

Cellular phones, tablet computers, and other wireless communication devices often can be configured to utilize two or more subscriber identity modules (SIMs), with each SIM used to support a corresponding separate cellular connection with a corresponding cellular network. To illustrate, one SIM may be used to establish a subscriber cellular connection for voice services with one mobile network operator, and another SIM is then used to establish a separate subscriber cellular connection with a different mobile network operator for data services. As another example, one SIM may be used for the user's primary, or default, mobile subscription, while another SIM is used to provide an alternative subscriber connection when the wireless communication device is no longer able to connect with the network provided by the primary mobile network operator; that is, the wireless communication device is “roaming” outside the range of the primary mobile network operator.

Some wireless devices with multiple SIMs are configured to support “cross-SIM calling” in which a wireless data connection is established via a “secondary” SIM, but the corresponding voice call is conducted in association with the identity of a “primary” SIM and its corresponding carrier (or mobile network operator) using the wireless data connection established using the secondary SIM. However, for the typical cross-SIM calling implementation, the wireless connection established via the secondary SIM is treated as a standard data connection and thus is not provided with quality of service (QoS) capabilities that are particularly suited for voice calling; consequently, the cross-SIM call may suffer from low voice call quality due to lack of a sufficient QoS over the wireless data connection.

### SUMMARY OF EMBODIMENTS

In accordance with one aspect, a method for conducting a call between a user equipment (UE) and a first cellular network via a second cellular network includes implementing a network slice between the UE and the second cellular network, the network slice having at least one quality of service (QoS) capability suitable for supporting the call. The method further includes establishing a network tunnel between the UE and the first cellular network via the network slice and communicating data packets for the call between the UE and the first cellular network via the network tunnel.

Various embodiments of this aspect can include the following, individually or in various combinations. The method further includes selecting the network slice from a plurality of network slices available from the second cellular network for use by the UE. Selecting the network slice can include selecting the network slice at the UE based on a list of available network slices provided by the second cellular network. Selecting the network slice further includes selecting the network slice based on a comparison of a QoS parameter for the call with a corresponding QoS capability of one or more available network slices. Establishing the network tunnel can include establishing the network tunnel based on a first subscriber identity of the UE that is associated with the first cellular network and the plurality of network slices available from the second cellular network for use by the UE can be based on a second subscriber identity of the UE that is associated with the second cellular network. The method can further include receiving, at the UE, an indication of the network slice to be implemented from the second cellular network in response to at least one of: transmission of an indication of at least one QoS requirement for the call to the second cellular network; or transmission of an indication that the call is to be supported by the first cellular network via the second cellular network. Establishing the network tunnel can include establishing the network tunnel based on a first subscriber identity of the UE that is associated with the first cellular network and implementing the network slice can include implementing the network slice based on a second subscriber identity of the UE that is associated with the second cellular network and different from the first subscriber identity. In this instance, the first subscriber identity is stored by a first subscriber identity module (SIM) of the UE and the second subscriber identity is stored by a second SIM of the UE. Establishing the network tunnel can include establishing the network tunnel between the UE and an Internet Protocol multimedia services (IMS) server of the first cellular network. The method can further comprise initiating the call at the UE by a user software application executing at the UE and providing a data interface for use for the call to the UE responsive to establishing the network tunnel.

In accordance with another aspect, a method includes conducting a cross-subscriber identity module (cross-SIM) call between a UE and a first cellular network via a network tunnel between the UE and the first cellular network that utilizes a network slice established between the UE and a second cellular network, the network slice being selected so as to provide at least one QoS capability in support of the cross-SIM call.

Various embodiments of this aspect can include the following, individually or in combination. The second cellular network can select the network slice based on the UE attempting to conduct the cross-SIM call. The UE can select the network slice from a list of network slices available from the second cellular network based on QoS capabilities supported by the network slices of the list. The network tunnel can include an evolved packet data gateway (ePDG) tunnel. The call can include one of a voice call or a video call.

In accordance with another aspect, a user equipment includes an application processor, a radio frequency (RF) modem coupled to the application processor, at least one antenna array coupled to the RF modem, and at least one memory to store instructions. The instructions are configured to manipulate one or both of the application processor or the RF modem to perform either or both of the aforementioned methods in their various embodiments.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram illustrating a mobile cellular system employing a user equipment (UE) with cross-SIM calling that utilizes a network slice providing call QoS in accordance with some embodiments.

FIG. 2 is a block diagram illustrating a hardware configuration of the UE of FIG. 1 in accordance with some embodiments.

FIG. 3 is a flow diagram illustrating a method cross-SIM calling using a network slice providing call QoS in accordance with some embodiments.

FIG. 4 is a ladder diagram illustrating an example operation of the method of FIG. 3 in accordance with some embodiments.

### DETAILED DESCRIPTION

Cross-SIM calling permits a mobile phone, cellular-enabled watch, tablet computer, vehicle cellular-communication system, or other UE to establish a data-based voice or video call via the cellular network associated with one SIM using a data connection provided via another SIM. However, as the data connection typically is not configured to provide certain QoS capabilities that support voice/video calling, such as low packet loss, low latency, and low jitter, the call is susceptible to low call quality. The Third Generation Partnership Project (3GPP) Fifth Generation New Radio (5G NR) standard set has promulgated technology directed to “network slicing,” which is a network architecture that facilitates the multiplexing of virtualized and independent logical networks (i.e., “network slices”) on the same physical network infrastructure, with each network slice being an isolated end-to-end network path that can be tailored to fulfill particular parameters for a corresponding application. The present disclosure describes embodiments of systems and methods for leveraging network slicing to provide cross-SIM calling with suitable QoS support for the wireless data connection over which the voice call traffic is routed. In at least one embodiment, when a call is initiated (either as a cellular voice service or as a voice-over-data service) and a first SIM designated to service the call is out-of-service (OOS) or otherwise does not have a serviceable connection to a corresponding first cellular network while a second SIM has a serviceable connection to a corresponding second cellular network, a cross-SIM calling process is initiated through which the UE utilizes the connection with the second network to request a network slice that has a QoS suitable for a voice call. In response to grant of the requested network slice, the UE then establishes a network tunnel with the first cellular network via the second cellular network. The first cellular network and the UE then communicate data packets for the call using the established network tunnel, with the network slice between the UE and the first network providing one or more QoS capabilities for the cellular transmission of the call packets between the first cellular network and the UE. As a result, the call can be provided a certain QoS level while utilizing the second network to provide satisfactory call quality in a manner transparent to the user, such that the call appears to be a call being conducted directly with the first cellular network.

For ease of reference, the term “subscriber identity module” or “SIM” is utilized to refer to a subscriber identity for a corresponding cellular network. However, it should be appreciated that reference to subscriber identity module or SIM also includes other modalities of representing a subscriber identity, such as a subscriber permanent identifier (SUFI), an international subscriber mobile identity (IMSI), as well as the mechanism for storing and/or representing such subscriber identity, such as a universal integrated circuit card (UICC), a universal subscriber identity module (USIM), and the like.

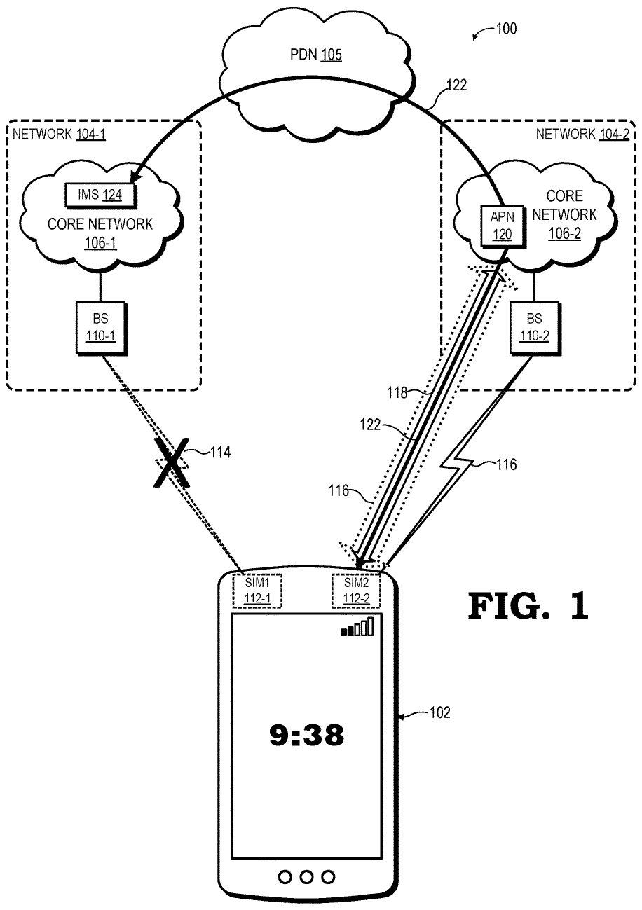

FIG. 1 illustrates a cellular communications system 100 employing cross-SIM calling with call QoS support via network slicing in accordance with some embodiments. As shown, the system 100 includes a user equipment (UE) 102 and one or more cellular networks 104 (referred to herein as “networks” for brevity). The UE 102 can include any of a variety of electronic wireless communication devices, such as a cellular phone, a cellular-enabled tablet computer or cellular-enabled notebook computer, a cellular-enabled watch or other wearable device, an automobile or other vehicle employing cellular services (e.g., for navigation, provision of entertainment services, in-vehicle mobile hotspots, etc.), and the like. Each network 104 is connected to one or more other networks 104 via at least one packet data network (PDN) 105, such as the Internet, via one or more private interconnecting data networks, or a combination thereof.

Each network 104 includes a core network 106 and a plurality of edge networks, or radio access networks (RANs), connected via a backhaul infrastructure. Each edge network includes a base station (BS) 110, such as base stations 110-1 and 110-2, operable to wirelessly communicate with UEs within signal range based on one or more radio access technologies (RATs). Examples of the base station 110 include, for example, a NodeB (or base transceiver station (BTS)) for a Universal Mobile Telecommunications System (UMTS) RAT implementation (also known as “3G”), an enhanced NodeB (eNodeB) for a Third Generation Partnership Project (3GPP) Long Term Evolution (LTE) RAT implementation, a 5G Node B (gNB) for a 3GPP Fifth Generation (5G) New Radio (NR) RAT implementation, and the like. As is well known in the art, the base stations 110 operate as an “air interface” to establish radio frequency (RF) wireless connections with UEs, and these wireless connections (or “links”) then serve as data and voice paths between the UEs and the core networks 106 for providing various services to the UEs, including voice services via circuit-switched networks or packet-switched networks, messaging services such as simple messaging service (SMS) or multimedia messaging service (MMS), multimedia content delivery, presence services, and the like.

Generally, the provision of services by a cellular network to a UE is subscription-based; that is, the particular services provided by, and the manner in which they are provided by, the network 104 is based on a mobile subscription established by the network for the corresponding UE. Each mobile subscription typically is associated with a corresponding unique subscriber identity, with the international mobile subscriber identity (IMSI) format as a frequently used format for subscriber identities. In many instances, the subscriber identity is encoded in an integrated circuit (IC) card for security purposes and to allow the user to switch UEs while maintaining the same subscriber identity by removing the IC card from one UE and installing it in another UE. Examples of an IC card include a Universal Integrated Circuit Card (UICC), and more specifically, a subscriber identity module (SIM). In other instances, the IC card is “virtualized” by instead storing the subscriber identity information and related information in a secure memory location in the UE itself. For ease of reference, example implementations of the subscriber identity being stored on, and represented by, a SIM are described. However, the techniques described herein are not limited to these examples, and thus references to a SIM for purposes of subscriber identity equally apply to other forms of subscriber identity representation unless explicitly noted.

As the services provided by an operator are subscriber-specific, in at least one embodiment the UE 102 employs two or more subscriber identities to facilitate access to two or more operator cellular networks. In the illustrated embodiment, this multiple subscriber identity configuration for the UE 102 is implemented via two SIMs 112: SIM 112-1 (“SIM1”) representing a subscriber identity associated with a subscription with network 104-1 and SIM 112-2 (“SIM2”) representing a subscriber identity associated with a subscription with network 104-2. SIMs 112-1 and 112-2 can be implemented as, for example, physical SIMs, virtual SIMs, or a combination thereof.

Each SIM 112 can be used by the UE 102 to establish a cellular connection with the corresponding network 104 based on a corresponding radio access technology (RAT). Examples of cellular RATs include, but are not limited to, the aforementioned 5G NR, LTE, Global System for Mobility (GSM), and UMTS, as well as Single Carrier Radio Transmission Technology (1×RTT), Worldwide Interoperability for Microwave Access (Wi-MAX), Code Division Multiple Access (CDMA), Time Division Multiple Access (TDMA), Evolution-Data Optimized (EV-DO), and the like. In some embodiments, the UE 102 employs a single SIM mode in which only a single SIM can be in use at the UE 102, and a user manually switches between SIMs 112 to switch between cellular connections. In other embodiments, the UE 102 employs a standby mode, such as Dual SIM Dual Standby (DSDS), in which a single RF resource (e.g., RF transceiver and modem) is shared by both SIMs 112 and in which the UE 102 alternates between the cellular connection of SIM 112-1 and the cellular connection of SIM 112-2 via time multiplexing. In still other embodiments, the UE 102 employs a dual active mode, such as Dual SIM Dual Active (DSDA), in which each SIM 112 has its own separate RF resource of the UE 102, thereby allowing both cellular connections to be active concurrently.

While facilitating the use of multiple subscriber identities can permit the UE 102 to connect to two or more operators, in some scenarios use of one of the cellular connections may be impracticable or impossible. For example, the UE 102 could roam beyond the air interface range of the base stations 110 of a network 104, thereby preventing the UE 102 from establishing any kind of cellular connection with that network 104, or the signal quality or connection quality of one cellular connection may limit its usability by the UE 102. As another example, the UE 102 could be located outside of the region associated with its primary, or “home,” mobile network operator, and thus be “roaming” in the coverage range of a secondary network, and the roaming charges that would be incurred if the UE 102 uses the cellular connection with the secondary network in support of, for example, voice services could be prohibitive for the user. In such instances, it could prove advantageous if a satisfactory cellular connection established for one subscription could be used to support services provided by the operator associated with the other subscription. In conventional UEs, the tight coupling between the subscriber, the software stack at the UE associated with the subscriber, and the operator's support of services based on the subscriber identity prevent such cross-over sharing of a cellular connection.

To address a situation in which the preferred, or “primary,” network 104 is out-of-service (OOS)(that is, the UE 102 is unable to establish a connection with the primary network 104 or any such connection is insufficient to provide a call (voice and/or video/voice) of sufficient quality), the UE 102 is configured to employ cross-SIM calling. In a cross-SIM calling scenario, assuming the UE 102 is able to establish a sufficient connection with the network 104 of a non-primary, or “secondary,” mobile network operator, the UE 102 can establish a connection with the primary network 104 via the secondary network 104 and the one or more PDNs 105 or other networks connecting the two cellular networks 104. However, as noted above, in conventional cross-SIM calling, there typically is little guarantee that the wireless connection with the secondary network 104 has a level of QoS support that is sufficient to support a voice/video call, and thus a conventional cross-SIM call can suffer from unacceptable quality due to the first link between the UE and the secondary mobile network operator.

To counter this, in at least one embodiment the cellular system 100 leverages network slicing techniques to provide sufficient QoS in support of a cross-SIM call. Network slicing, first introduced for 5G NR radio access technologies (RATs) and radio access networks (RANs), is a network architecture that facilitates the multiplexing of virtualized and independent logical networks on the same physical network infrastructure, with each “network slice” being an isolated logical, or “virtual,” end-to-end network tailored to a corresponding set of requirements, such as low latency, guaranteed bandwidth, support for long-battery-life internet-of-things (IoT) devices, and so on. Also, a network slice can have dedicated resources in the network of a single cellular network or across multiple cellular networks. As such, a network slice can comprise one or both of one or more radio access network (RAN) slices and/or one or more core network slices. Of particular import to the following description is the ability of a mobile network operator to provide certain QoS parameters on a per-slice basis. For example, a cellular network may provide one network slice that supports high bandwidth, another network slice that supports low latency, and yet another network slice that provides near-zero dropped packet rates.

The UE 102 thus utilizes network slicing provided by the secondary network to attempt to establish a wireless connection with the secondary network via a network slice that has QoS capabilities appropriate for the type of call to be conducted (this set of one or more QoS capabilities referred to herein as “call QoS,” and the network slice supporting such call QoS is consequently referred to herein as a “call QoS slice”), such as low latency and low packet drop rate for a voice call or low latency and high throughput for a video call. With a call QoS slice established between the UE 102 and the secondary network 104, the UE 102 can then use this call QoS slice to establish a network tunnel with the primary network 104, and then conduct the call using the network tunnel with call-level QoS support for the wireless connection between the UE 102 and the secondary network 104 via the established call QoS slice.

To illustrate, assume for the following that the network 104-1 is the primary network and the network 104-2 is the secondary network. In response to a software application executing on the UE 102 attempting to initiate a call (voice or video) while the UE 102 is unable to establish a connection with the primary network 104-1 (00S condition 114), the UE 102 triggers cross-SIM calling by establishing a wireless connection 116 with the BS 110-2 of the secondary network 104-2 using SIM 112-2 and the subscriber identity represented thereby. As part of this process, the secondary network 104-2 can inform the UE 102 of the various network slice types available to the UE 102, and the QoS capabilities provided by each, and the UE 102 can identify a network slice type that provides a QoS suitable for the call being initiated, and request that the secondary network 104-2 allow the UE 102 to attach to a network slice having the identified network slice type. In other embodiments, the UE 102 informs the secondary network 104-2 that it is attempting to establish a call, and in some cases, the desired QoS capabilities for the call, and the secondary network 104-2 selects the network slice to be used by the UE 102 on the basis of this information. In either approach, assuming the secondary network 104-2 grants the UE 102 the use of a suitable network slice, the UE 102 and secondary network 104-2 establish a call QoS slice 118 for the wireless connection 116 (and which also may extend into the core network 106-2 as a core network slice) between the UE 102 and a corresponding gateway of the core network 106-2, such as an access point name (APN) gateway 120.

The UE 102 can then use the SIM 112-1 (and its represented subscriber identity) to establish a network tunnel 122 with the primary network 104-1 via the wireless connection 116 with the secondary network 104-2. In particular, the UE 102 establishes the network tunnel 122 via the call QoS slice 118 established between the UE 102 and the core network 106-2 of the secondary network 104-2, and via the connection between the core network 106-2 and the core network 106-1 of the primary network 104-1 via the one or more PDNs 105. The network tunnel 122 can comprise any of a variety of tunnels suitable for providing voice/video call services between a UE and one cellular network via a wireless connection with another cellular network. To illustrate, a network operator typically provides internet packet (IP) call services via an IP multimedia service (IMS) server, and thus the network tunnel 122 can include an IP security (IPSec) tunnel or, more specifically, an evolved packet data gateway (ePDG) tunnel established between the UE 102 and an IMS server 124 of the core network 106 via the call QoS slice 118 and the one or more PDNs 105. In this approach, the UE 102 would then use the SIM 112-1 and its subscriber identity for the authentication process employed to authenticate the UE 102 to the IMS server 124 and other components of the core network 106-1 (e.g., edge gateways) when establishing the ePDG tunnel. After the network tunnel 122 is established, the UE 102 and the IMS server 124 or other supporting network component can continue the call establishment process and then exchange uplink and downlink data packets in support of the established call.

Thus, using the technique described above, the UE 102 is able to adapt to the 00S condition 114 for the primary network 104-1 by establishing a wireless connection 116 with the secondary network 104-2 using a call QoS slice that provides one or more QoS capabilities suitable for establishing an acceptable QoS level for the call, and then using this call QoS slice to implement a network tunnel with the primary network 104-1, with the call then being conducted via this network tunnel. As such, the UE 102 obtains the benefit of conducting a call with the primary network 104-1, which typically includes the use of the primary subscriber identity associated with the UE 102 and avoidance of call roaming charges, while also providing a predictable or, in some instances, guaranteed QoS level suitable for the call even though the wireless connection is a data connection with the secondary network 104-2, which otherwise typically might not be afforded a QoS level suitable for conducting a voice call or video call.

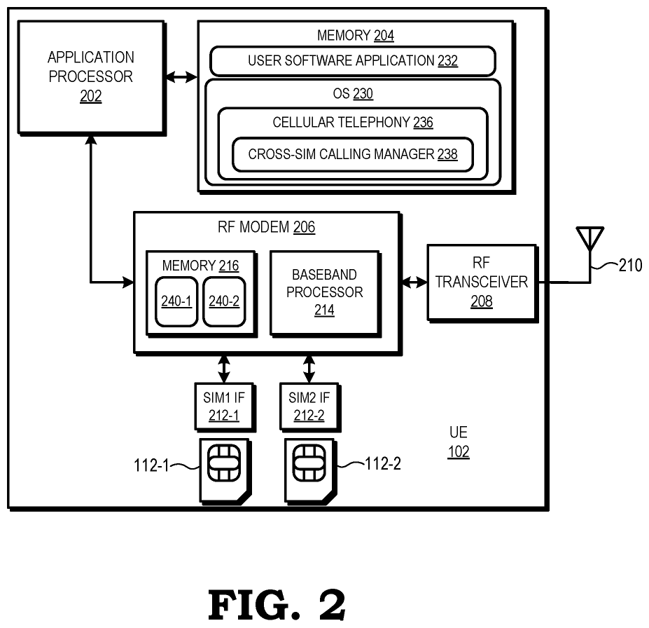

FIG. 2 illustrates an example hardware configuration for the UE 102 in accordance with some embodiments. In the depicted example, the UE 102 includes an application processor 202 (e.g., a central processing unit (CPU) or other general processor), a system memory 204, one or more RF modems 206, one or more RF transceivers 208, and one or more antenna arrays 210 suitable for RF signaling and signal processing in one or more frequency bands typically associated with the corresponding RAT (e.g., a 5G NR RAT).

The RF modem 206 includes a baseband processor 214 and a memory 216, which can include, for example, a Flash memory, non-volatile random access memory (NVRAM) or other non-volatile memory, or static RAM (SRAM) or dynamic RAM (DRAM) or other volatile memory, or a combination thereof. The RF modem 206 is coupled to two or more SIM interfaces (IFs) 212, such as SIM1 IF 212-1 and SIM2 IF 212-2 for receiving and connecting to SIMs 112-1 and 112-2, respectively. As one or both of the SIMs 112-1 or 112-2 can be implemented as a virtual SIM (“eSIM”), the corresponding SIM interface 212 can represent, for example, the secure memory location in the UE 102 that stores the subscriber identity and associated information represented by the virtual SIM. Note that in the depicted embodiment, the UE 102 is configured to support either a single SIM mode or a DSDS mode, in which the RF resources (RF modem 206, RF transceiver 208, and antenna array(s) 210) are shared between the SIMs 112-1 and 112-2 via time multiplexing when each SIM 112 has an ongoing cellular connection. In other embodiments, the UE 102 can be configured to support a Dual SIM Dual Active (DSDA) mode, with a separate instance of the RF resources for each SIM 112 so that cellular connections for both SIMs 112-1 and 112-2 can be active concurrently. Further, it will be appreciated that the UE 102 can include a number of additional components omitted from FIG. 2 for ease of illustration including, for example, one or more displays, one or more touchscreens, keypads, mice, touchpads, microphones, speakers, and other user input/output devices, one or more sensors, batteries or other power sources, graphical processing units (GPUs) or other coprocessors, and the like.

As a general operational overview, the application processor 202 executes executable instructions from a software stack that includes an operating system (OS) 230 and one or more user software applications, such as user software application 232, and which further can include the protocol stacks executed by the RF modem 206. The OS 230, through manipulation of the application processor 202, manages the general operation of the various hardware components of the UE 102 as well as supports the execution of the one or more user software applications, with the executable instructions representing the OS 230 and the user software application typically accessed from system memory 204 for execution by the application processor 202. The modules of the OS 230 thus include a cellular telephony module 236 for controlling or facilitating the higher-level cellular-related operations of the UE 102, including subscriber identity management, initiation, control, and tear-down of cellular connections, authentication, interfacing between cellular connections and the user software applications, and the like. As part of this, the cellular telephony module 236 includes a cross-SIM calling manager 238 configured to manage certain operations of the UE 102 for establishing a cross-SIM call, including the establishment of a call QoS slice with the secondary network, establishing a network tunnel with the primary network via the call QoS slice, and the like. Further, the memory 216 of the RF modem 206 stores a protocol stack 240 for each subscriber identity of the UE 102, such as protocol stacks 240-1 and 240-2 for SIMs 112-1 and 112-2, respectively. Each protocol stack 240 stores executable instructions that, when executed by the baseband processor 214, manipulate the baseband processor 214 to perform various operations in accordance with a RAT protocol or other communication protocol associated with the air interface provided by the base station 110 (FIG. 1) of the network 104 for which the UE 102 is attempting to establish a communication link. As is well known, such operations typically are associated with the lower-level layers of a network protocol, such as some or all of the physical, data link, and network layers, while the OS 230 and the user software applications support the higher-level layers of the network protocol, such as the transport, session, presentation, and application layers.

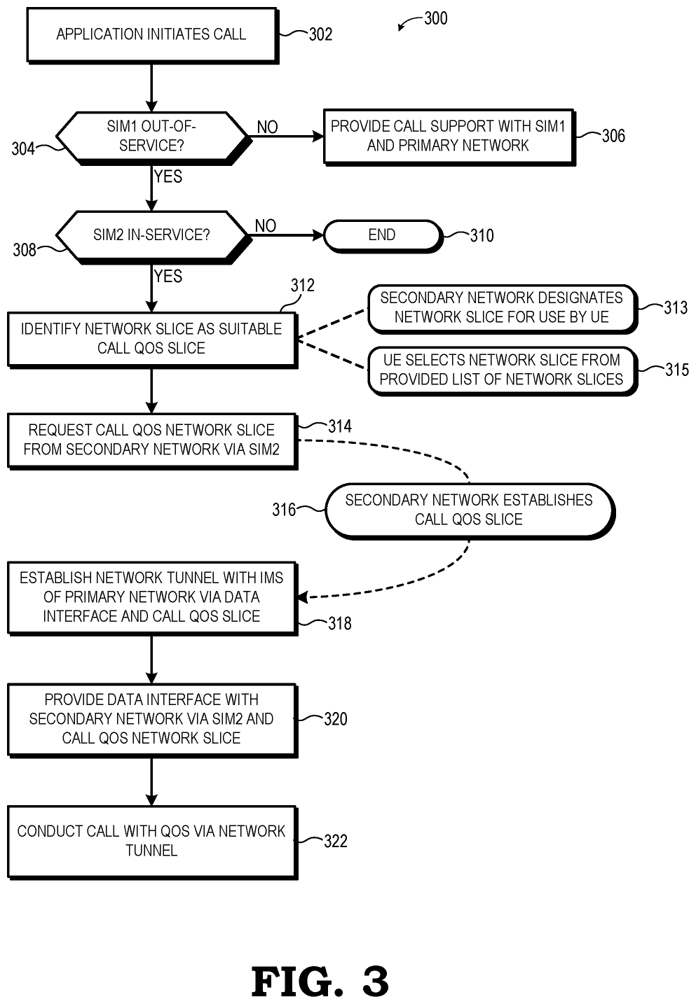

FIG. 3 illustrates an example method 300 of operation of system 100 for supporting cross-SIM calling using a call QoS slice in accordance with some embodiments. The method 300 is described with reference to the embodiments of the UE 102 depicted in FIG. 2 but is not limited to such configurations and instead can be adapted to any of a variety of configurations of a multiple-subscriber UE using the guidelines provided herein. For illustrative purposes, method 300 is described in the example scenario identified above in which the network 104-1 is the primary cellular network while the network 104-2 is the secondary cellular network.

The method 300 initiates at block 302 with the user software application 232 initiating a call. For example, the user software application 232 can be a voice telephony application used to conduct voice calls, a chat or teleconference application used to conduct voice/video calls, and the like. As part of call initiation, the user software application 232 requests a data interface for supporting the call from the cellular telephony module 236 of the OS 230. In response to this request, at block 304 the cellular telephony module 236 determines the current state of a connection with the primary network 104-1 using SIM 112-1, or more specifically, whether there is an OOS condition or other condition that prevents the UE 102 from establishing a wireless connection directly with the primary network 104-1. If the primary network 104-1 is in-service for the UE 102 using SIM 112-1, then at block 306 the cellular telephony 236 establishes a wireless connection with the primary network 104-1 and provides a network interface for the wireless connection to the user software application 232 for conducting the call.

However, in the event that there is an OOS condition or other condition that prevents the use of a direct wireless connection with the primary network 104-1 for use in conducting the initiated call, at block 308 the cellular telephony module 236 determines whether the secondary network 104-2 is in-service. If not (and assuming only two subscriber identities in this example), then the UE 102 does not have a wireless connection with a cellular network available for supporting the call, and thus at block 310 the cellular telephony module 236 reports an error in establishing a data interface for the call to the user software application 232, in response to which the user software application 232 terminates the attempted call and method 300 terminates.

Otherwise, in the event that the secondary network 104-2 is in-service and thus available to establish a wireless connection with the UE 102 (if one is not already established), then the UE 102 and the secondary network 104-2 operate to establish a network slice with QoS support for the initiated call (that is, a call QoS slice) between the UE 102 and the secondary network 104-2. Accordingly, at block 312 a network slice offered by the secondary network 104-2 is selected or otherwise identified as the network slice to be used as the call QoS slice. This process can be implemented in a variety of ways. As represented by block 313, this identification process can be performed by the secondary network 104-2. For example, in some embodiments, the secondary network 104-2 may support one or more network slice types specifically for cross-SIM calling, and thus when the cross-SIM calling manager 238 submits a connection request for establishing a wireless connection between the UE 102 and the secondary network 104-2 using the subscriber identity of SIM 112-2, the connection request or subsequent communication can include, for example, an indication that the connection request is in association with a cross-SIM call. In response, a network slicing management component or other component of the secondary network 104-2 can select a network slice specifically designated as suitable for cross-SIM calling and then instruct the UE 102 to attempt to be attached via the selected network slice. Alternatively, the cross-SIM calling manager 238 can advertise the QoS parameters it is seeking for the initiated call, such as a specified maximum latency threshold or a specified minimum throughput level, and the network slicing management component or other component of the secondary network 104-2 can select a network slice that meets, or is closest to meeting, the advertised QoS capabilities and then instruct the UE 102 to attempt to attach to the selected network slice.

Alternatively, as represented by block 315, the UE 102 can identify the network slice to be used as the call QoS slice. In this approach, the secondary network 104-2 can provide network slice information to the UE 102, either on an ad hoc basis when the UE 102 attempts to camp on the secondary network 104-2 or through prior advertisement of the network slicing configuration of the secondary network 104-2 (e.g., while the UE 102 is idle). The network slice information, in at least some embodiments, comprises a list or other data structure representing available network slices and information such as an identifier, device requirements and application/service requirements, QoS capabilities (features), service level agreements (SLAs), configured resources, and the like for each available network slice. In some embodiments, the network slices available to the UE 102 for use may be based on the subscriber identity associated with SIM 112-2. That is, the number/type of network slices made available to the UE 102 may be dependent on a pre-arranged service level associated with the subscriber identity of SIM 112-2. Among conventional network slice types, the network slice types further may include, for example, one or more cross-SIM call slice types configured to provide certain call QoS parameters in support of cross-SIM calls. Alternatively, the network slice types can include network slice types not specifically formulated for cross-SIM calling, and the UE 102 can then select the network slice type suited for providing sufficient call QoS for the initiated call. The cross-SIM calling manager 238 of the UE 102 can, for example, select a supported network slice type through a priori identification of the network slice type as providing QoS capabilities suitable for the initiated call, or through comparison of advertised QoS capabilities for one or more network slice types to the corresponding QoS requirements for the initiated call. For example, the user software application 232 may signal to the cellular telephony module 236 that it needs a data interface that provides a maximum latency of, for example, 20 milliseconds (ms) and a minimum instantaneous throughput of 144 kilobits-per-second, and the cross-SIM calling manager 238 then may select an available network slice type that meets these two QoS criteria at a minimum.

After identifying a particular network slice to serve as the call QoS slice for the initiated call, whether by the secondary network 104-2 or by the UE 102, at block 314 the cross-SIM calling manager 238 coordinates with the protocol stack 240-2, and the RF modem 206 more generally, to request a wireless connection with the secondary network 104-2 that uses the network slice identified at block 312 (as the call QoS slice) on the basis of the subscriber identity associated with SIM 112-2. At block 316 the secondary network 104-2 acts upon this request to establish the requested wireless connection (e.g., wireless connection 116, FIG. 1) if not already established, and further to establish the requested network slice (e.g., network slice 118, FIG. 1) with the UE 102. In response to establishing the wireless connection and call QoS network slice, at block 318 the cross-SIM calling manager 238 then establishes a network tunnel (e.g., network tunnel 122, FIG. 1) with the IMS server 124 of the primary network 104-1 using the established wireless connection and call QoS slice with the secondary network 104-2, and on the basis of the subscriber identity provided by the SIM 112-1. As noted above, this network tunnel can include, for example, an IPSec tunnel, and more specifically, an ePDG tunnel. As explained above, this network tunnel is established using the subscriber identity of the SIM 112-1, and thus can access the various services provided by the primary network 104-1 in association with that subscriber identity, including, for example, various IMS services (e.g., Voice over IP (VoIP)) as well as certain QoS capabilities for the services provided.

With the network tunnel in place, at block 320 the OS 230 presents a data interface linked to the network tunnel to the user software application 232 for use in conducting the initiated call and at block 322 the UE 102 conducts the call using the data interface and associated network tunnel. To illustrate, for uplink communications, the data representing the voice and/or video content of the call is provided to the data interface, whereupon the data is packetized and transmitted over the network tunnel to the IMS server 124 using, for example, a VoIP protocol. This transmission includes transmission via the established call QoS slice between the UE 102 and the BS 110-2 (and in some instances, into the core network 106-2) with QoS support associated with the network slice utilized for the call QoS slice. Likewise, for downlink communications, packetized data representing voice and/or video content is provided from the IMS server 124 to the core network 106-2 of the secondary network 104-2 via the PDN 105, and then the packetized data is transmitted to the UE 102 from the secondary network 104-2 via the established call QoS slice with its attendant QoS support.

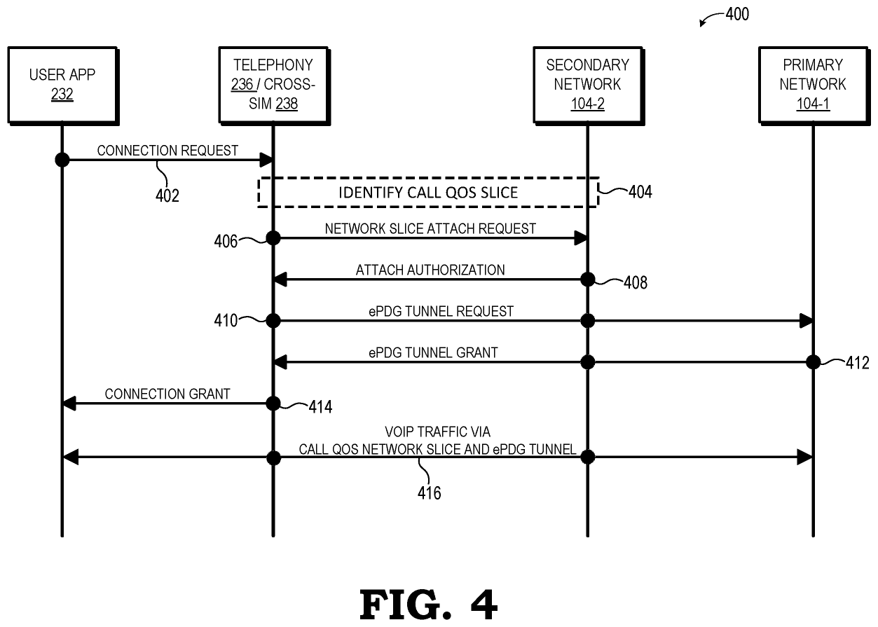

FIG. 4 illustrates a ladder diagram 400 depicting an example operation of the method 300 in accordance with some embodiments. In this example, the user software application 232 submits a data connection request 402 for a data interface to be used for conducting a call (one example of the call initiation process of block 302). In this example, the primary network 104-1 has an 00S condition with respect to the UE 102 and the secondary network 104-2 is in-service for the UE 102. Accordingly, the UE 102 and/or the secondary network 104-2 operate to identify a network slice to be utilized as the call QoS slice as represented by block 404 and described above with reference to blocks 312, 313, and 315 of FIG. 3. With a suitable network slice identified, the cross-SIM calling manager 238 directs the protocol stack 240-2 to issue a network slice attach request 406 to the secondary network 104-2, and in some instances, to provide the subscriber identity of SIM 112-2 for authentication purposes. In response to authorizing the subscriber identity and availability/suitability of the requested network slice, a network slicing manager or other component of the core network 106-2 transmits an attach authorization 408 to the UE 102, in response to which the UE 102 attaches to the BS 110-2 and thus the secondary network 104-2 using the requested network slice (blocks 314 and 316, FIG. 3). The cross-SIM calling manager 238 then directs the RF modem 206 to transmit an ePDG tunnel request 410 to the primary network 104-1 via the wireless connection with the secondary network 104-2 using the subscriber identity of SIM 112-1 for authentication purposes, and the primary network 104-1 authenticates the subscriber and replies with an ePDG tunnel grant 412 that is transmitted to the UE 102 via the secondary network 104-2 (block 318, FIG. 3). In response to an indication that the ePDG tunnel is initiated, the cellular telephony module 236 issues a connection grant 414 to the user software application 232, with the connection grant 414 indicating network interface details (such as a port, a destination IP address, etc.)(block 320, FIG. 3) In response to the connection grant 414, the user software application 232 then transmits and receives VoIP traffic 416 via the established data interface, the associated ePDG tunnel, and the call QoS slice that supports the portion of the ePDG tunnel that extends between the UE 102 and the secondary network 104-2.

In some embodiments, certain aspects of the techniques described above are implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium can be in source code, assembly language code, object code, or other instruction format that is interpreted or otherwise executable by one or more processors.

A computer-readable storage medium includes any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method for conducting a call between a user equipment (UE) and a first cellular network via a second cellular network, the method comprising:
implementing a network slice between the UE and the second cellular network, the network slice having at least one quality of service (QoS) capability suitable for supporting the call;
establishing a network tunnel between the UE and the first cellular network via the network slice; and
communicating data packets for the call between the UE and the first cellular network via the network tunnel.

2. The method of claim 1, further comprising:
selecting the network slice from a plurality of network slices available from the second cellular network for use by the UE.

3. The method of claim 2, wherein selecting the network slice comprises selecting the network slice at the UE based on a list of available network slices provided by the second cellular network.

4. The method of claim 3, wherein selecting the network slice further comprises selecting the network slice based on a comparison of a QoS parameter for the call with a corresponding QoS capability of one or more available network slices.

5. The method of claim 2, wherein:
establishing the network tunnel comprises establishing the network tunnel based on a first subscriber identity of the UE that is associated with the first cellular network; and
the plurality of network slices available from the second cellular network for use by the UE is based on a second subscriber identity of the UE that is associated with the second cellular network.

6. The method of claim 1, further comprising:
receiving, at the UE, an indication of the network slice to be implemented from the second cellular network in response to at least one of: transmission of an indication of at least one QoS requirement for the call to the second cellular network; or transmission of an indication that the call is to be supported by the first cellular network via the second cellular network.

7. The method of claim 1, wherein:
establishing the network tunnel comprises establishing the network tunnel based on a first subscriber identity of the UE that is associated with the first cellular network; and
implementing the network slice comprises implementing the network slice based on a second subscriber identity of the UE that is associated with the second cellular network and different from the first subscriber identity.

8. The method of claim 7, wherein:
the first subscriber identity is stored by a first subscriber identity module (SIM) of the UE; and
the second subscriber identity is stored by a second SIM of the UE.

9. The method of claim 1, wherein establishing the network tunnel comprises establishing the network tunnel between the UE and an Internet Protocol multimedia services (IMS) server of the first cellular network.

10. The method of claim 1, further comprising:
initiating the call at the UE by a user software application executing at the UE; and
providing a data interface for use for the call to the UE responsive to establishing the network tunnel.

11. A method comprising:
conducting a cross-subscriber identity module (cross-SIM) call between a user equipment (UE) and a first cellular network via a network tunnel between the UE and the first cellular network that utilizes a network slice established between the UE and a second cellular network, the network slice being selected so as to provide at least one quality of service (QoS) capability in support of the cross-SIM call.

12. The method of claim 11, wherein the second cellular network selects the network slice based on the UE attempting to conduct the cross-SIM call.

13. The method of claim 11, wherein the UE selects the network slice from a list of network slices available from the second cellular network based on QoS capabilities supported by the network slices of the list.

14. The method of claim 1, wherein the network tunnel comprises an evolved packet data gateway (ePDG) tunnel.

15. The method of claim 1, wherein the call comprises one of a voice call or a video call.

16. A user equipment (UE) comprising:
an application processor;
a radio frequency (RF) modem coupled to the application processor;
at least one antenna array coupled to the RF modem; and
at least one memory to store instructions, the instructions configured to manipulate one or both of the application processor or the RF modem to:
implement a network slice between the UE and a first cellular network, the network slice having at least one quality of service (QoS) capability suitable for supporting a call between the UE and a second cellular network via the first cellular network;
establish a network tunnel between the UE and the second cellular network via the network slice; and
communicate data packets for the call between the UE and the second cellular network via the network tunnel.

17. The UE of claim 16, wherein the instructions further are configured to manipulate one or both of the application processor or the RF modem to:
select the network slice from a list of available network slices provided by the first cellular network and based on a comparison of a QoS parameter for the call with a corresponding QoS capability of one or more available network slices.

18. The UE of claim 17, wherein:
the network tunnel is established based on a first subscriber identity of the UE that is associated with the second cellular network; and
the list of available network slices from the first cellular network for use by the UE is based on a second subscriber identity of the UE that is associated with the first cellular network.

19. The UE of claim 16, wherein:
the network tunnel is established based on a first subscriber identity of the UE that is associated with the second cellular network; and
the network slice is implemented based on a second subscriber identity of the UE that is associated with the first cellular network and different from the first subscriber identity.

20. The UE of claim 16, wherein the instructions further are configured to manipulate one or both of the application processor or the RF modem to:
initiate the call at the UE by a user software application executing at the UE; and
provide a data interface for use for the call to the UE responsive to establishing the network tunnel.
